(19) United States
(12) Patent Application Publication
(10) Pub. No.: US 2007/0228974 A1
(43) Pub. Date: Oct. 4, 2007

(54) PLASMA DISPLAY PANEL

(76) Inventors: Bong-Kyoung Park, Suwon-si (KR); Eun-Young Jung, Suwon-si (KR)

Correspondence Address: CHRISTIE, PARKER & HALE, LLP, PO BOX 7068, PASADENA, CA, 91109-7068, US

(21) Appl. No.: 11/678,519

(22) Filed: Feb. 23, 2007

(30) Foreign Application Priority Data
Mar. 28, 2006 (KR) 10-2006-0028079

(51) Int. Cl. H01J 17/49

(52) U.S. Cl. 313/586; 313/584

(57) ABSTRACT

A plasma display panel includes a first substrate and a second substrate facing each other. A barrier rib together with the first substrate and the second substrate defines a plurality of discharge cells for generating a gas discharge. First discharge electrodes extend in a direction in correspondence with respective discharge cells. Third discharge electrodes are disposed in the barrier rib, extend in the direction and correspond with respective first discharge electrodes in the respective discharge cells. Fourth discharge electrodes are disposed in the barrier rib, extend in the direction, are separated from respective third discharge electrodes and face respective third discharge electrodes with respect to centers of the discharge cells. Address electrodes intersect the direction. Phosphor layers are formed in the discharge cells.

### CROSS-REFERENCE TO RELATED PATENT APPLICATION

This application claims priority to and the benefit of Korean Patent Application No. 10-2006-0028079, filed on Mar. 28, 2006, in the Korean Intellectual Property Office, the entire content of which is incorporated herein by reference.

### BACKGROUND OF THE INVENTION

1. Field of the Invention

The present invention relates to a plasma display panel, and more particularly, to a plasma display panel which is capable of maximizing a discharge space and increasing the life span of the panel.

2. Description of the Related Art

In general, plasma display panels display predetermined images by exciting phosphors using ultraviolet generated by gas discharge. Since the plasma display panels may be thin shaped and implemented as high-definition large-screen displays, the plasma display panels have been noted as next generation displays.

FIG. 1 is an exploded perspective view of a conventional opposed discharge plasma display panel, and FIG. 2 is a cross-sectional view along a line II-II of FIG. 1.

Referring to FIG. 1, the plasma display panel includes a first substrate 111 and a second substrate 121 that face each other. On the first substrate 111, a first barrier rib 1241 is formed. A plurality of first discharge electrodes 112 and a plurality of second discharge electrodes 113 that are extended in a direction are disposed in the first barrier rib 1241. A protective layer 116 is formed on the surface of the first barrier rib 1241. A second barrier rib 1242 is formed on the second substrate 121. Also, a plurality of address electrodes 122 are arranged on the surface 121a of the second substrate 121 toward the first substrate 111, in a manner to intersect the direction of first discharge electrodes 112 and second discharge electrodes 113. The address electrodes 122 are covered with a dielectric layer 123. Phosphor layers 125 are formed in discharge cells 126 defined by the lateral surfaces 124a of the barrier rib 124 together with the surface 111a of the first substrate 111 and the surface 123a of the dielectric layer 123.

However, in the conventional opposed discharge plasma display panel, since a distance between a first discharge electrode 112 and a second discharge electrode 113 is long, an initial discharge start voltage is high. Also, due to the characteristic of opposed discharge, as illustrated in FIG. 2, since an electric field is formed only linearly, a discharge is generated only in a part of each discharge cell 126 not in the entire part of the discharge cell 126.

### SUMMARY OF THE INVENTION

In accordance with the present invention a plasma display panel is provided which is capable of maximizing a wide discharge space and increasing the life span of the panel.

According to an aspect of the present invention, a plasma display panel includes a first substrate and a second substrate which face each other. A barrier rib is disposed between the first substrate and the second substrate, and together with the first substrate and the second substrate defines a plurality of discharge cells for generating a gas discharge. First discharge electrodes extend in a direction in correspondence with respective discharge cells. Third discharge electrodes are disposed in the barrier rib, extend in the direction and correspond with respective first discharge electrodes in the respective discharge cells. Fourth discharge electrodes are disposed in the barrier rib, extend in the direction, are separated from respective third discharge electrodes and face respective third discharge electrodes with respect to centers of the discharge cells. Address electrodes intersect the direction. Phosphor layers are formed in the discharge cells.

The first discharge electrodes may be disposed on a surface of the first substrate facing the second substrate.

The plasma display panel may include a first dielectric layer covering the first discharge electrodes.

The plasma display panel may include a protective layer covering at least one portion for the first dielectric layer.

Each of the first discharge electrodes may include a bus electrode.

The third discharge electrode and the fourth discharge electrode facing each other with respect to a discharge cell center may be electrically connected to each other.

The same electrical signal may be applied to the third discharge electrode and to the fourth discharge electrode facing each other with respect to a discharge cell center.

The plasma display panel may further include a plurality of second discharge electrodes extending in parallel to the first discharge electrodes, separated from the first discharge electrodes, and in correspondence with the first discharge electrodes.

Each of the first discharge electrodes and the second discharge electrodes may include a bus electrode.

The first discharge electrodes and the second discharge electrodes may be electrically connected to each other.

The same electrical signal may be applied to the first discharge electrodes and to the second discharge electrodes.

The second discharge electrodes and the third discharge electrodes may be electrically connected to each other.

The same electrical signal may be applied to the first discharge electrodes and the fourth discharge electrodes, and the same electrical signal may be applied to the second discharge electrodes and the third discharge electrodes.

The first discharge electrodes and the second discharge electrodes may be disposed on a surface of the first substrate facing the second substrate.

The plasma display panel further may include a first dielectric layer covering the first discharge electrodes and the second discharge electrodes.

The plasma display panel may further include a protective layer covering at least one portion of the first dielectric layer.

The plasma display panel may further include a protective layer covering a least one portion of lateral surfaces of the barrier rib.

The address electrodes may be disposed on a surface of the second substrate facing the first substrate.

The plasma display panel may further include a second dielectric layer covering the address electrodes.

### BRIEF DESCRIPTION OF THE DRAWINGS

FIG. 1 is an exploded perspective view of a conventional plasma display panel.

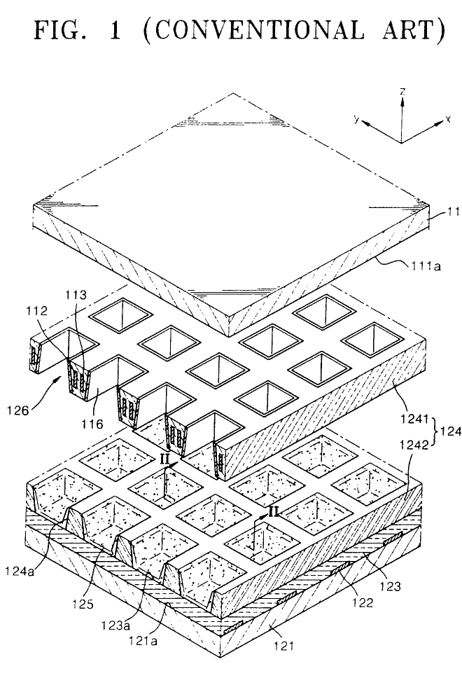

FIG. 2 is a cross-sectional view along a line II-II of FIG. 1.

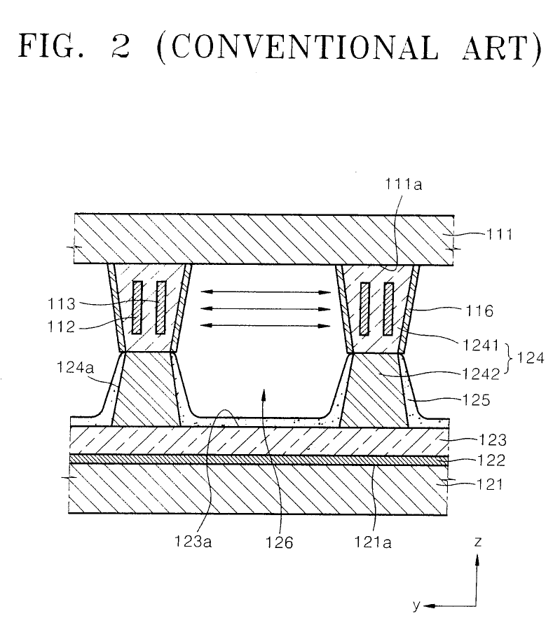

FIG. 3 is an exploded perspective view of a plasma display panel according to an embodiment of the present invention.

FIG. 4 is a cross-sectional view along a line IV-IV of FIG. 3.

FIG. 5 is a cross-sectional view of a plasma display panel according to another embodiment of the present invention.

FIG. 6 is a cross-sectional view of a plasma display panel according to yet another embodiment of the present invention.

### DETAILED DESCRIPTION

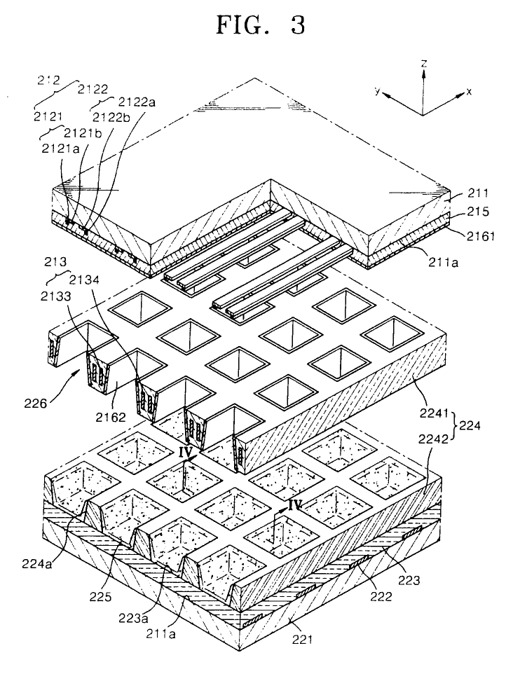

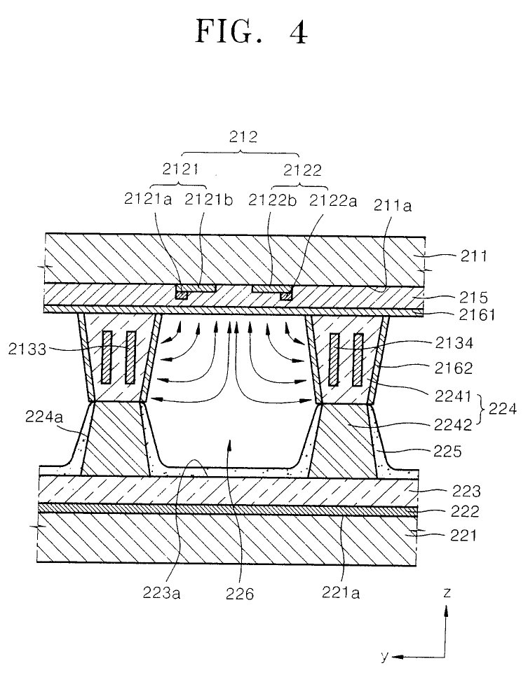

Referring to FIGS. 3 and 4, a first substrate 211 and a second substrate 221 are disposed in a manner to face each other. The first substrate 211 and the second substrate 221 may be made of a transparent material such as glass.

A barrier rib 224 is formed between the first substrate 211 and the second substrate 221. The barrier rib 224, as illustrated in FIGS. 3 and 4, can include a first barrier rib 2241 formed on the first substrate 211 and a second barrier rib 2242 formed on the second substrate 221, as necessary. Hereinafter, for the convenience of description, as illustrated in FIGS. 3 and 4, the barrier rib 241 includes the first barrier rib 2241 and the second barrier rib 2242. However, the present invention is not limited to this exemplary embodiment. The barrier rib 224 defines a plurality of discharge cells 226 together with the first substrate 211 and the second substrate 221. In FIG. 3, the barrier rib 224 is formed in a lattice pattern to define the discharge cells 226, however, the present invention is not limited to this exemplary embodiment. That is, the barrier rib 224 may be formed in various patterns, such as a stripe pattern arranged in a direction, for example, in an x direction of FIG. 3. Also, the discharge cells 226 defined by the barrier rib 224 may be formed of various shapes and with various arrangements, such as a delta shape.

In FIG. 3, the X-Y cross-section of a discharge cell 226 is a square. However, the cross-section of the discharge cell 226 may be a polygon, such as a triangle, a pentagon, and the like, or a circle or an ellipse, and the like. These cross-sections are also applied to embodiments that will be described later.

In an exemplary embodiment the barrier rib 224, particularly, the first barrier rib 2241 as illustrated in FIGS. 3 and 4 is made of a dielectric material since a plurality of third discharge electrodes 2133 and a plurality of fourth discharge electrodes 2134, which will be described later, are formed in the first barrier rib 2241.

That is, by forming the barrier rib 224 with a dielectric material, direct electrical connections between the third discharge electrodes 2133 and the fourth discharge electrodes 2134 and damages of the discharge electrodes 2133 and 2134 due to collision of charged particles are prevented. The dielectric material may include PbO, B₂O₃, SiO₂, and the like.

As illustrated in FIGS. 3 and 4, the lateral surfaces of the barrier rib 224 may be covered with protective layers 2162. The protective layers 2162 are formed by depositing a material such as MgO. The protective layers 2162 act to emit secondary electrons and activate a discharge, as well as protect the barrier rib 224.

In each discharge cell 226 defined by the first substrate 211, the second substrate 221, and the barrier rib 224, a first discharge electrode 2121 and a second discharge electrode 2122 are included. That is, the plasma display panel includes a plurality of discharge electrode pairs 212 which are extended in a direction and respectively correspond to the discharge cells 226. In FIGS. 3 and 4, the discharge electrode pairs 212 are extended in the x direction, and are disposed on the surface 211a of the first substrate 211 toward the second substrate 221. However, the present invention is not limited to this exemplary embodiment.

The first discharge electrode 2121 and the second discharge electrode 2122 may be formed of a conductive metal, such as aluminum or copper, and the like. If light generated in the plasma display panel is emitted from the discharge electrode pairs 212, that is, if light is emitted to the outside through the first substrate 211, the discharge electrode pairs 212 may be transparent electrodes.

In order to form such transparent electrodes, a transparent material such as indium tin oxide (ITO) may be used.

Referring further to FIG. 4, the first discharge electrode 2121 and the second discharge electrode 2122 can further include a first bus electrode 2121a and a second bus electrode 2122a, respectively, as necessary. Since transparent parts 2121b, 2122b of the first and second discharge electrodes 2121, 2122 generally have high resistance, the bus electrodes 2121a, 2122a act to prevent a voltage from dropping due to such high resistance. Accordingly, the bus electrodes 2121a, 2122a may be formed of silver, copper, gold, or aluminum, and the like, that have low resistance and high conductivity. Also, by including a black addition agent in the bus electrodes 2121a, 2122a or by allowing the bus electrodes 2121a, 2122a to have a multi-layer structure including a layer formed of a black material, it is possible to improve contrast.

The first discharge electrode 2121 and the second discharge electrode 2122 are connected to a connection cable (not shown) located near the edges of the plasma display panel, thereby receiving a supply voltage. Here, it is possible that only the bus electrodes 2121a, 2122a are connected to the connection cable, however, the present invention is not limited to this exemplary embodiment.

The discharge electrode pairs 212 are covered with a first dielectric layer 215. The first dielectric layer 215 acts to prevent direct electric connection between the first and second discharge electrodes 2121, 2122 included in the discharge electrode pairs 212, and prevents damage to the discharge electrodes 2121, 2122 due to collision of charged particles to the discharge electrodes 2121, 2122. The first dielectric layer 212 may be made of PbO, B₂O₃, SiO₂, and the like. If light generated in the plasma display panel is emitted to the outside through the first substrate 211, the first dielectric layer 215 may be formed of a transparent material.

In an exemplary embodiment, at least one portion of the first dielectric layer 215 is covered with a protective layer 2161. In FIGS. 3 and 4, a protective layer 2161 covers the entire surface of the first dielectric layer 215. The protective layer 2161 is formed by depositing a material such as MgO. The protective layer 2161 acts to emit secondary electrons and activate a discharge, as well as protect the first dielectric layer 215.

In FIGS. 3 and 4, a plurality of third discharge electrodes 2133 and a plurality of fourth discharge electrodes 2134 are disposed in the barrier rib 224, particularly, in the first barrier rib 2241. Each of the third discharge electrodes 2133 is extended in a direction in the barrier rib 224, for example, in an x direction in FIG. 3. Each of the fourth discharge electrodes 2134 faces the corresponding third discharge electrode 2133 and a discharge cell 226 is located between the fourth discharge electrode 2134 and the third discharge electrode 2133. The fourth discharge electrode 2134 is separated from the third discharge electrode 2133.

A plurality of address electrodes 222 are arranged such that the address electrodes' direction intersects the direction of first discharge electrodes 2121, the direction of second discharge electrodes 2122, the direction of third discharge electrodes 2133, and the direction of fourth discharge electrodes 2134. Such an electrode arrangement is for generating an address discharge between the address electrodes 222 and at least one electrode among the first through fourth discharge electrodes 2121, 2122, 2133, 2134 and then generating a sustain discharge between the first through fourth discharge electrodes 2121, 2122, 2133, 2134.

The address electrodes 222 may be arranged on the second substrate 221 toward the first substrate 211. In this case, a second dielectric layer 223 may be further formed to cover the address electrodes 222, in order to prevent damage to the address electrodes 222 due to collision of charged particles to the address electrodes 222 when a discharge occurs. The second dielectric layer 223 is formed of a dielectric material capable of inducing charged particles. The dielectric material may include PbO, B₂O₃, SiO₂, and the like.

Phosphor layers 225 are formed in the discharge cells 226, more particularly, on the upper surface 223a of the second dielectric layer 223 and the lateral surfaces 224a of the barrier rib 224. The phosphor layers 225 are formed by applying one of a red-emitting phosphor, a green-emitting phosphor and a blue-emitting phosphor, and a phosphor paste in which solvent and binder are mixed to the upper surface 223a of the second dielectric layer 223 and the lateral surfaces 224a of the barrier rib 224 and then drying and firing the resultant structure. The red-emitting phosphor may include Y(V, P)O₄:Eu, and the like, the green-emitting phosphor may include Zn₂SiO₄:Mn, YBO₃:Tb, and the like, and the blue-emitting phosphor may include BAM:Eu, and the like.

In the plasma display panel depicted in FIGS. 3 and 4 a discharge gas may be filled in the discharge cells 226. The discharge gas may be a Ne—Xe mixed gas in which Xe is included by 5% through 15%. At least one part of Ne may be substituted by He, as necessary. Also, it is possible that other gases are used or the inner parts of the discharge cells 226 are maintained in a vacuum state, as necessary

As seen in FIGS. 3 and 4, the phosphor layers 225 are located on the upper surface 223a of the second dielectric layer 223 and the lateral surfaces 224a of the barrier rib 224. However, since the phosphor layers 225 emit visual light using ultraviolet emitted from the discharge gas, the locations of the phosphor layers are not limited to the upper surface 223a of the second dielectric layer 223 and the lateral surfaces 224a of the barrier rib 224, but are only in the discharge cells 226.

In the plasma display panel with the above-described structure, according to the embodiment of the present invention, since a sustain discharge is performed between the first discharge electrodes 2121, the second discharge electrodes 2122, the third discharge electrodes 2133, and the fourth discharge electrodes 2134, a discharge may be generated in a discharge space wider than in the conventional opposed discharge plasma display panel. Accordingly, discharge efficiency is improved. Also, in the conventional opposed discharge plasma display panel, since a distance between discharge electrodes that are included in the barrier rib 224 and face each other is long, a discharge start voltage is very high. However, in the plasma display panel according to the embodiment of the present invention, since a distance between discharge electrodes is short, the high discharge start voltage problem can be solved. Furthermore, in the case of the plasma display panel according to the embodiment of the present invention, since the distance between the discharge electrodes is short, a sustain discharge voltage for generating a sustain discharge is low, resulting in significant reduction of consumption power of the plasma display panel.

In the case of the plasma display panel illustrated in FIGS. 3 and 4, the third discharge electrode 2133 and the fourth discharge electrode 2134 between which the discharge cell 226 is formed and which face each other are electrically connected to each other. That is, the same electrical signal is applied to the third discharge electrode 2133 and the fourth discharge electrode 2134 between which the discharge cell 226 is formed and which face each other. Also, the first discharge electrode 2121 and the second discharge electrode 2122 are electrically connected to each other. That is, the same electrical signal is applied to the first discharge electrode 2121 and the second discharge electrode 2122.

In this case, when a sustain discharge is performed, the sustain discharge is performed between the first discharge electrode 2121 and the third discharge electrode 2133 and between the second discharge electrode 2122 and the fourth discharge electrode 2134, as illustrated by the arrows in FIG. 4. That is, since the sustain discharge is generated as illustrated by the arrows in FIG. 4, a distance between discharge electrodes in which the sustain discharge is generated is short. Also, since an electric field in the discharge cells 226 is curved without being distributed in a straight line, a discharge space may be enlarged. Accordingly, it is possible to significantly improve efficiency of the plasma display panel and reduce consumption power.

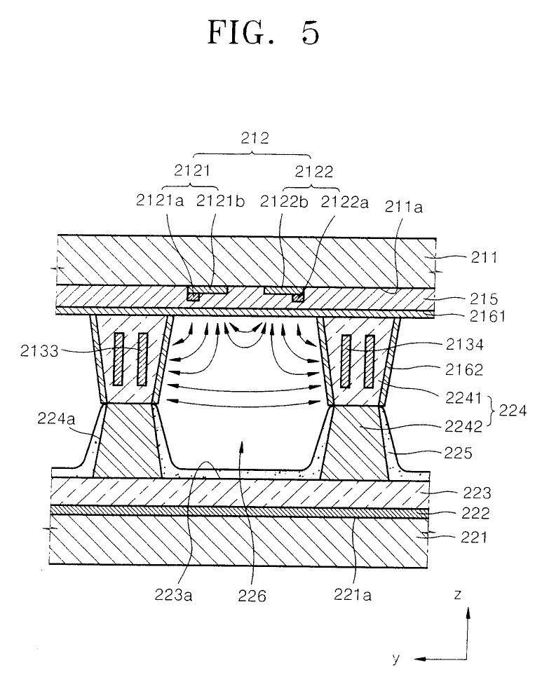

FIG. 5 is a cross-sectional view of a plasma display panel according to another embodiment of the present invention.

A difference between the plasma display panel according to the embodiment illustrated in FIG. 5 and the plasma display panel according to the embodiment illustrated in FIG. 4 is a relationship between electrodes in which a sustain discharge is generated.

In the case of the plasma display panel according to the embodiment illustrated in FIG. 4, the third discharge electrode 2133 and the fourth discharge electrode 2134 between which the discharge cell 226 is formed and which face each other are electrically connected to each other, and also the first discharge electrode 2121 and the second discharge electrode 2122 are electrically connected to each other. However, in the case of the plasma display panel according to the embodiment illustrated in FIG. 5, the first discharge electrode 2121 and the fourth discharge electrode 2134 are electrically connected to each other, and the second discharge electrode 2122 and the third discharge electrode 2133 are electrically connected to each other. That is, in the case of the plasma display panel according to the embodiment illustrated in FIG. 5, the same electrical signal is applied to the first discharge electrode 2121 and the fourth discharge electrode 2134, and the same electrical signal is applied to the second discharge electrode 2122 and the third discharge electrode 2122.

In this case, as illustrated by arrows in FIG. 5, sustain discharges are generated between the first discharge electrode 2121 and the third discharge electrode 2133, between the second discharge electrode 2122 and the fourth discharge electrode 2134, and between the third discharge electrode 2133 and the fourth discharge electrode 2134. That is, a distance between discharge electrodes in which a sustain discharge is generated is short. Also, since an electric field in a discharge cell 226 is curved without being distributed in a straight line, a discharge space may be enlarged. Accordingly, it is possible to significantly improve efficiency of the plasma display panel and reduce consumption power.

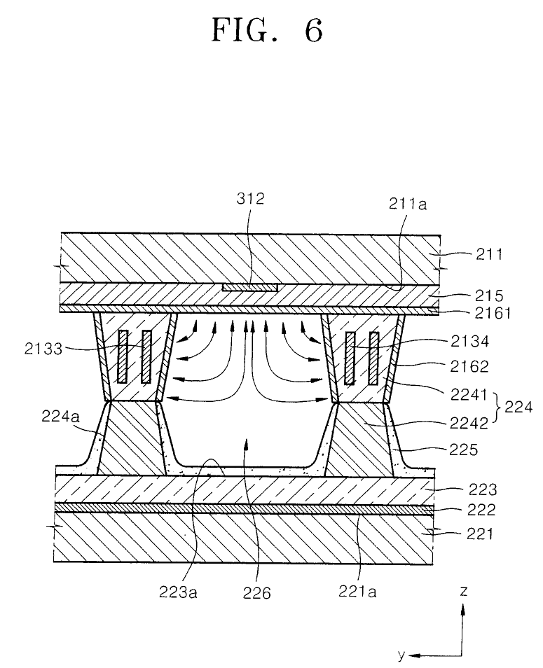

FIG. 6 is a cross-sectional view of a plasma display panel according to yet another embodiment of the present invention.

In the plasma display panel according to the embodiment illustrated in FIG. 6, differently from the plasma display panels according to the above-described embodiments, only a single discharge electrode is disposed on the first substrate 211 in corresponding to each discharge cell 226. That is, referring to FIG. 6, only single discharge electrode 312 is disposed without a second discharge electrode on the surface 211a of the first substrate 211 toward the second substrate 221, and a third discharge electrode 2133 and a fourth discharge electrode 2134 are disposed in the barrier rib 224, corresponding to each discharge cell 226. In this case, since a sustain discharge is generated between the single discharge electrode 312 and the third discharge electrode 2133 and between the single discharge electrode 312 and the fourth discharge electrode 2134, a distance between discharge electrodes in which a sustain discharge is generated is short. Also, since an electric field in the discharge cell 226 is curved without being distributed in a straight line, a discharge space is enlarged. Accordingly, it is possible to significantly improve efficiency of the plasma display panel and reduce consumption power.

As described above, according to the present invention, it is possible to maximize a discharge space of a plasma display panel and significantly improve a life space of the plasma display panel.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A plasma display panel comprising:
a first substrate and a second substrate facing each other;
a barrier rib disposed between the first substrate and the second substrate, and together with the first substrate and the second substrate defining a plurality of discharge cells for generating a gas discharge;
a plurality of first discharge electrodes extending in a direction and corresponding with respective discharge cells;
a plurality of third discharge electrodes disposed in the barrier rib, extending in the direction, and corresponding with respective first discharge electrodes in the respective discharge cells;
a plurality of fourth discharge electrodes disposed in the barrier rib and extending in the direction, respective fourth discharge electrodes being separated from respective third discharge electrodes and facing respective third discharge electrodes with respect to centers of the discharge cells;
a plurality of address electrodes intersecting the direction; and
a plurality of phosphor layers formed in the discharge cells.

2. The plasma display panel of claim 1, wherein the first discharge electrodes are disposed on a surface of the first substrate facing the second substrate.

3. The plasma display panel of claim 2, further comprising a first dielectric layer covering the first discharge electrodes.

4. The plasma display panel of claim 3, further comprising a protective layer covering at least one portion of the first dielectric layer.

5. The plasma display panel of claim 1, wherein each of the first discharge electrodes includes a bus electrode.

6. The plasma display panel of claim 1, wherein the third discharge electrode and the fourth discharge electrode facing each other with respect to a discharge cell center are electrically connected to each other.

7. The plasma display panel of claim 1, wherein the same electrical signal is applied to the third discharge electrode and the fourth discharge electrode facing each other with respect to a discharge cell center.

8. The plasma display panel of claim 1, further comprising a plurality of second discharge electrodes extending in parallel to the first discharge electrodes, separated from and in correspondence with the first discharge electrodes.

9. The plasma display panel of claim 8, wherein each of the first discharge electrodes and the second discharge electrodes includes a bus electrode.

10. The plasma display panel of claim 8, wherein the first discharge electrodes and the second discharge electrodes are electrically connected to each other.

11. The plasma display panel of claim 8, wherein a same electrical signal is applied to the first discharge electrodes and to the second discharge electrodes.

12. The plasma display panel of claim 8, wherein the first discharge electrodes and the fourth discharge electrodes are electrically connected to each other, and the second discharge electrodes and the third discharge electrodes are electrically connected to each other.

13. The plasma display panel of claim 8, wherein a same electrical signal is applied to the first discharge electrodes and to the fourth discharge electrodes, and a same electrical signal is applied to the second discharge electrodes and to the third discharge electrodes.

14. The plasma display panel of claim 8, wherein the first discharge electrodes and the second discharge electrodes are disposed on a surface of the first substrate facing the second substrate.

15. The plasma display panel of claim 14, further comprising a first dielectric layer covering the first discharge electrodes and the second discharge electrodes.

16. The plasma display panel of claim 15, further comprising a protective layer covering at least one portion of the first dielectric layer.

17. The plasma display panel of claim 1, further comprising a protective layer covering a least one portion of lateral surfaces of the barrier rib.

18. The plasma display panel of claim 1, wherein the address electrodes are disposed on a surface of the second substrate facing the first substrate.

19. The plasma display panel of claim 18, further comprising a second dielectric layer covering the address electrodes.
